(19) United States
(12) Patent Application Publication
(10) Pub. No.: US 2024/0043347 A1
(43) Pub. Date: Feb. 8, 2024

(54) FABRICATION OF RF-TRANSPARENT CERAMIC COMPOSITE STRUCTURES BY COMPOSITIONAL GRADING

(71) Applicant: ASELSAN ELEKTRONIK SANAYI VE TICARET ANONIM SIRKETI, Ankara (TR)

(72) Inventors: Hansu BIROL, Ankara (TR); Hande HANEDAN, Ankara (TR); Mustafa Fatih AKBOSTANCI, Ankara (TR); Akin DALKILIC, Ankara (TR); Ozgur BIRER, Ankara (TR); Mehmet Erim INAL, Ankara (TR); Sebnem SAYGINER, Ankara (TR)

(73) Assignee: ASELSAN ELEKTRONIK SANAYI VE TICARET ANONIM SIRKETI, Ankara (TR)

(21) Appl. No.: 18/256,934

(22) PCT Filed: Dec. 20, 2021
(86) PCT No.: PCT/TR2021/051435

§ 371 Date: Jun. 12, 2023

(30) Foreign Application Priority Data
Dec. 23, 2020 (TR) 2020/21406

(51) Int. Cl. C04B 35/82; C04B 35/628; H01Q 1/42

(52) U.S. Cl. CPC C04B 35/82; C04B 35/62886; H01Q 1/42; C04B 2235/3418; C04B 2235/3217; C04B 2235/3463; C04B 2235/3409; C04B 2235/3225; C04B 2235/3244; C04B 2235/5232; C04B 2235/5224; C04B 2235/5228; C04B 2235/604; C04B 2235/6028

(57) ABSTRACT

A method is provided and suggests grading of a CMC (Ceramic Matrix Composite) structure as a function of dielectric constant by altering the solid loading (SL) ratio of the individual composite layers. The slurry is applied either by impregnation into the ceramic fabrics or by coating on ceramic fibers. The final structure is prepared by piling up prepregs or weaving ceramic fibers with specific SL ratio, drying and firing.

### CROSS REFERENCE TO THE RELATED APPLICATIONS

This application is the national phase entry of International Application No. PCT/TR2021/051435, filed on Dec. 20, 2021, which is based upon and claims priority to Turkish Patent Application No. 2020/21406, filed on Dec. 23, 2020, the entire contents of which are incorporated herein by reference.

### TECHNICAL FIELD

The present invention is a method for making dielectrically-graded ceramic matrix composite structures exhibiting broadband radio frequency (RF) transparency.

### BACKGROUND

Airborne structures flying at a speed of 5 or more times that of sound reach hypersonic regime. Missile radomes, nosecones, RF-transparent windows/caps/shields in such condition are exposed to severe thermal, mechanical and environmental constraints. Consequently, most of the engineering plastics and/or the ceramic fibers blended with as such plastics cannot withstand typical conditions inherent to this regime. Depending on the time of the flight, temperatures can easily exceed 800° C., which leaves no material choice other than ceramics.

Monolithic bulk ceramics for such applications are manufactured by conventional techniques such as slip casting and glass melt molding/spinning. However, the production metrics of these techniques are not favourable. Moreover, these routes are not applicable to develop broadband RF-transparent structures demanding multiple layers of carefully-selected and matched materials with precise dielectric properties (dielectric constant, dielectric loss, etc.) and design constraints (thickness, surface roughness, planarity, etc.).

There is ample amount of information about generic structures fabricated by CMC (Ceramic Matrix Composite) technology. Increased fracture toughness, high thermal insulation capacity, lightness, ease of shaping are the distinctive benefits of CMC over traditional bulk ceramics.

Furthermore, CMC technology plays a critical role in fabrication of airborne structures operating at super/hypersonic speeds. However, there is limited information about the dielectric properties of as such CMC's in the open literature. This is quite unexpected since critical components such as radomes, nosecones, RF-transparent windows/caps/shields, which are exposed to high temperatures, thermal and thermo-mechanical shocks and rain/dust/sand erosion, can ideally be fabricated by CMC technology.

Although rare, there is more information for hybrid structures for the aforementioned applications. The word “hybrid” here, indicates the combination of an engineering polymer (polyimide honeycomb, polyimide or cyanate esther-based resins and/or foams) and a ceramic fiber or cloth.

U.S. Pat. No. 5,738,750 explains the method to develop multilayer radome layers in which a honeycomb structure is covered with piles of quartz cloth that is composed of silica fiber (65% wt.) infiltrated by silica-based resin (35% wt.) on both sides of the honeycomb. The inorganic resin is either polysilicone or polysilozane, which is converted to silica or silicon nitride after pyrolysis, respectively. However, a clear description of how the radome shape is formed by joining these layers is not clearly mentioned.

In U.S. Pat. No. 7,118,802, the requirements for a missile radome flying at 6+Mach is disclosed. The proposed structure is composed of a load bearing layer of colloid-impregnated FR-CMC and a thermal insulation layer. The colloid is a ceramic suspension with 40-50% wt. solids loading (alumina or silica), while the insulation layer is a foam with 45% opening filled with ceramic particles. The layers are bonded with a high temperature stable adhesive.

The construction of the broadband HARM anti-radiation missile is sketched in [1]. According to this model, 3 mm thick, low dielectric honeycomb structure is sandwiched between the thinner, high dielectric layers. Similar to the disclosed information in open literature, there is no explanation as to how the broadband radome is constructed.

Fabrication techniques for RF-transparent airborne structures operating in broad frequency band and flying close to/at/above hypersonic speeds are not disclosed in open literature. Traditional approach for developing broadband structure is either by stacking single layers each with specific dielectric as a sandwich or by attaching physical layers such as tapers to the surface of the structure (radome wall, for instance). However, these approaches are limited by both structural and operational constraints:
Sandwich structures are composed of layers with low and high dielectric constant materials for broadband characteristic. This requires absolute CTE (Coefficient of Thermal Expansion) compatibility of neighbouring layers to avoid delamination and fracture amid thermal and thermo-mechanical shocks.
Chemical compatibility of dissimilar layers must be ensured to avoid the regions of uncontrolled dielectric constant, which can occur due to the excessive thermal energy leading to the formation and mobility of unpredicted dielectric phases.
Sandwich structures need to have high dielectric layers of a very finite thickness range only, which makes them more prone to fracture due to the aforementioned incompatibility issues.
High temperature generated at/around the hypersonic regime quickly deteriorates the attached layers such as tapers. This is particularly valid if such layers are of organic nature.

### SUMMARY

Solids loading (SL) ratio is a critical parameter in colloidal processing of ceramics as this ratio directly affects the final density of the product. High SL ratio increases the density and hence, the dielectric constant of the material. The method disclosed in this invention suggests grading of a CMC (Ceramic Matrix Composite) structure as a function of dielectric constant by altering the SL ratio of the individual composite layers. Unlike sandwich structures, which are composed of dissimilar materials, there is only one type of ceramic material in the proposed composite structure. This approach not only ensures the thermomechanical and chemical compatibility between the layers but also results in a superior broadband performance with respect to the sandwich structures.

Fabrication of RF-transparent and broadband ceramic structures for the hypersonic regime is a complicated process. Compared to current broadband radome manufacturing techniques, the innovation disclosed in this patent claims the following unique features:
The ceramic composite is graded as a function of the dielectric constant.
Grading is made by altering the SL ratio of the ceramic slurry for each layer.
The adjustments in SL ratio of the slurry is reflected proportionally in the material density and hence, the dielectric constant amid direct proportionality between these factors.
All composite layers are prepared from one type of ceramic matrix only.
The use of one matrix material assures the physical, chemical and thermo-mechanical compatibility of the overall structure
SL ratio from 10% to 90% is applicable with special additives.
SL ratio from 30% to 80% is applicable for most of the aforementioned ceramic systems depending on the acceptable minimum critical strength (lower limit) and the upper colloidal stability level (upper limit) for each system.
The slurry can be impregnated into ceramic fabrics weaved from continuous ceramic fibers such as quartz, silica, alumina, mullite, alumina/boric oxide/silica, alumina/yttria, zirconia at varying compositions, for development of planar structures. Each layer is pressed in wet state, dried and fired.
The slurry in slurry baths can be coated/wetted on fiber bundles, fiberssuch as E-glass, quartz, silica, alumina, mullite, alumina/boric oxide/silica, alumina/yttria, zirconia at varying compositions, dried and wrapped around tubular molds for fabrication of cylindrical or conical objects.
The technique is applicable to the ceramic fabrics and ceramic fibers in development due to the facility of using one matrix composition that is compatible with the ceramic fabric/fiber.
Slurry can be selected from any of the ceramic compositions mentioned previously or customized as long as the physical, chemical and thermo-mechanical compatibility with the continuous ceramic fabric/fiber is guaranteed.
Compared to a composite with dissimilar materials, the presented innovation brings enhanced microwave design capability and flexibility by narrowing the focus to the properties of one type of matrix material.

### BRIEF DESCRIPTION OF THE DRAWINGS

FIG. 1 shows the relationship between the density of slip cast fused silica samples with different solid loading ratios sintered (all samples are sintered at the same temperature).

FIGS. 2A-2C show the simulation of insertion losses (s21) of virgin, A-sandwich and graded silica. The losses over the entire frequency range is below 1 dB for the graded silica (red dotted line represents the 1 dB loss level).

### DETAILED DESCRIPTION OF THE EMBODIMENTS

Ceramics are widely used building blocks of RF-transparent airborne components such as missile radomes, nosecones, RF caps and windows moving at super/hypersonic velocities. This does not preclude alternative material options such as organic/inorganic/filler-added polymers applicable in this regime. However, ceramics possess inherently strong intermolecular bonds giving them significantly improved mechanical strength, chemical and thermal stability and abrasion resistance. Moreover, they can be used both in oxidizing and reducing atmospheres depending on their chemistry. These are attractive features sought especially when the surface temperature of the aforementioned structures exceeds 1.000° C. under severe environmental conditions such as chemical attack, rain/dust/sand erosion, etc.

The traditional ceramic manufacturing route consists of well-known steps: raw material preparation for processing, shaping and firing followed by post processes such as machining (grinding, polishing, lapping) and alternatively by coating to further extend material's endurance against thermal, abrasive and environmental impacts. Among several techniques, slip casting and glass melt spinning are the most-widely used to manufacture big ceramic structures such as missile radomes operating in the super/hypersonic regime. The former technique relies on the capillary effect to compact and shape the ceramic powder dispersed in an aqueous slip when placed in a gypsum mold. The latter uses hot molding and/or hot spinning to shape the molten glass-ceramic poured on a spinning mold. Both techniques have been used for manufacturing of commercial missile radomes for decades. There are advantages and disadvantages of each technique. But from a broader perspective, both techniques have significant limitations:
The monolithic bulk ceramic is inherently fragile. Fracture is catastrophic (immediate and complete)
Shaping process is limited. Complex structures with low tolerances are achieved only by post processes.
Process yield in both techniques is quite low. The production yield for both techniques is approximately 40-50%.
Multi-layering for broadband characteristic is practically impossible due to very finite layers of high dielectric constant materials, which need to be integrated to the thicker low dielectric constant layers.
Physical, chemical, thermal and thermo-mechanical (CTE) mismatch between different layers lead to delamination, fracture or malfunctions even if the extremely thin high dielectric constant layer is attached to the thicker low dielectric constant layer.

O/O CMC's (Oxide/Oxide CMC) can address the aforementioned shortcomings of monolithic bulk ceramics. These materials are composed of an oxide fiber (network) and an oxide matrix. The traditional oxide ceramic fiber material is alumina (Al₂O₃). However, alumina suffers grain growth and hence, creeps at high temperatures. Therefore, it is usually mixed with SiO₂ and B₂O₃ to delay/prevent creep behavior. Another motive to mix these oxides with Al₂O₃ is to improve the oxidation and the alkaline resistance of the composite [2-4]. The matrix, which is the other part of the composite, is an oxide ceramic such as alumina, silicate, mullite, zirconia compatible with the ceramic fiber. It is prepared as a slurry, which is a mixture of the ceramic powder, solvent, surfactant, binder and similar functional components. Each of these ingredients has a specific function; the ceramic powder is the functional element giving the physical, thermal, mechanical and electrical properties of the composite together with the fibers; the solvent is the carrier of the powder and it determines the rheology of the mixture by dissolving the binder, whereas the surfactant enhances the reactivity of the powder by modifying its surface properties.

The ceramic powder represents the solid content of the slurry and it forms the matrix of the composite. The other solids in the slurry are additives oxidized at much lower temperatures. Therefore, the SL ratio is the ceramic powder weight percent or ratio in the slurry. SL ratio is a critical slurry parameter: When the powder is homogenously dispersed in the slurry, the number of particle to particle contacts per unit volume is higher for a slurry with higher SL. This indicates an increase in the green density of the material, which also improves the sintered density due to the enhanced necking and material diffusion through particle contacts during sintering.

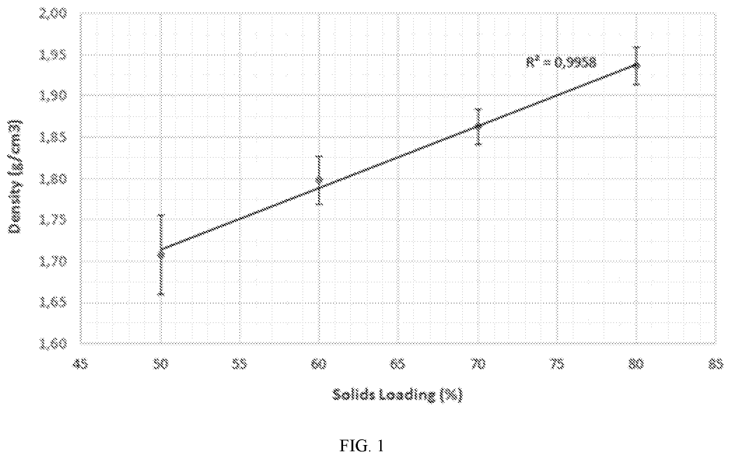

Density and SL relation of slip cast fused silica (SCFS) samples prepared at 50, 60, 70 and 80 percent SL ratios fired at the same sintering temperature is presented in FIG. 1. The strong correlation between the two parameters (R 2=0,9958) is evident. The relationship between the SL ratio and the dielectric constant is directly proportional but relatively supressed; the effect of 30% variation in SL ratio results in a change of 10% only in dielectric constant (Table 1). Moreover, the tgδ at 60% SL ratio exhibits an increased value, which is ascribed to possible contamination during processing. To sum up, the major idea behind dielectric grading disclosed in this work is accomplished by preparing the single layers of the composite with a specific SL ratio.

TABLE 2
SL Ratio, Density Dielectric Constant and Loss of SCFS

| SL Ratio | Density (g/cm³) | ε | tgδ |
|---|---|---|---|
| 50 | 1.71 | 3.02 | 0.001 |
| 60 | 1.80 | 3.04 | 0.005 |
| 70 | 1.86 | 3.34 | 0.001 |
| 80 | 1.94 | 3.40 | 0.001 |

The slurry can be prepared from oxide ceramics such as Al₂O₃, SiO₂, mixture of Al₂O₃ and SiO₂ mixture of Al₂O₃, SiO₂, B₂O₃, ZrO₂, mixtures of Al₂O₃, ZrO₂, mixtures of Y₂O₃ and Al₂O₃, etc. The binary or ternary compositions of these and other metal oxides can be prepared by mixing the constituents at different ratios to optimize the material characteristics further. The purity, the particle size and distribution, the specific surface area and the morphology of the ceramic powder are critical factors, which directly impact the sintering behavior and the dielectric response of the composite. The SL ratio of the slurry should be selected in a specific range; it should neither be too low leading to an extremely weak inter particle bonding nor too high resulting in a highly segregated microstructure. Usually, 10% to 90% by weight should work with appropriate additives, whereas, 30% to 80% is a safer range for the ceramic systems discussed.

The starting point for dielectric grading is preparation of slurries with different SL ratio. The composite structures can be fabricated by using ceramic fiber networks (fabrics) or continuous ceramic fiber bundles. For planar composites, ceramic fabrics impregnated with slurries of desired dielectric constant are piled up together in wet state, pressed, dried and fired. Alternatively, the bundles of ceramic fibers can be immersed into the slurry baths with specific dielectric constant, dried, wrapped around the cylindrical molds, removed from the mold and fired. The process of piling up of fabrics or wrapping of fibers can be repeated with as many different slurries (with specific SL ratio) as desired to fulfill the RF design. It is important to re-mention that the slurry material discussed here is of one material only (like silica or alumina) and the dielectric constant of this single material is tuned by varying its SL ratio per composite layer.

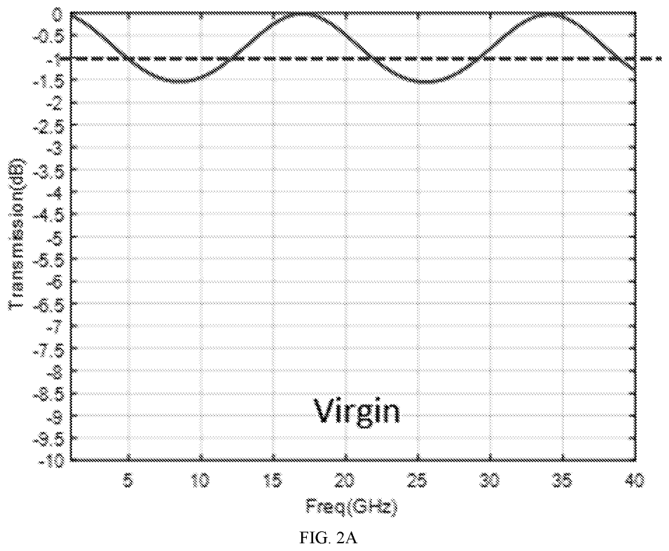

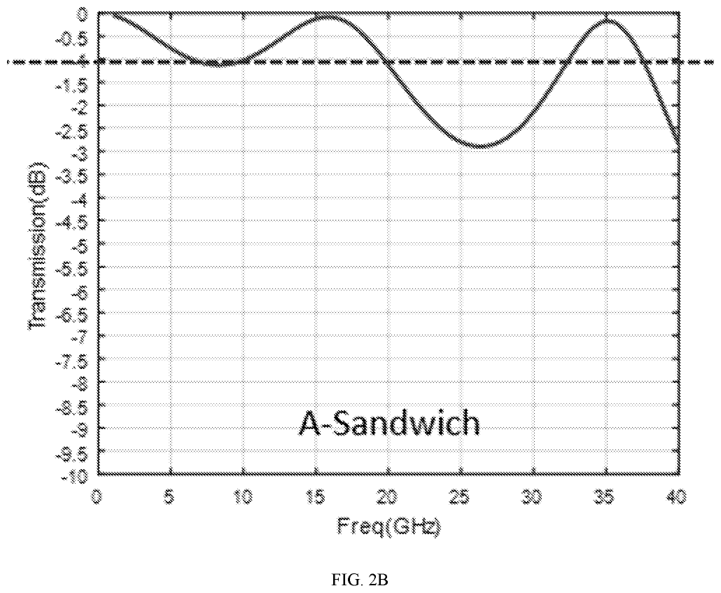

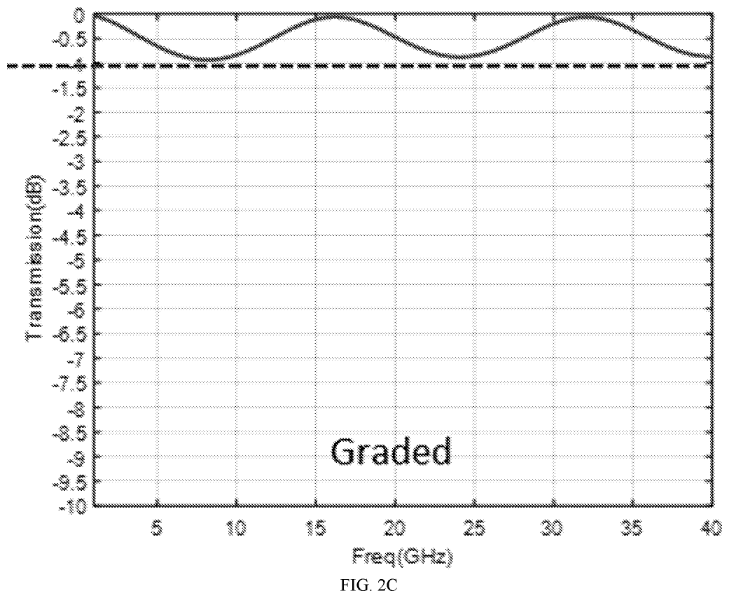

Dielectric grading of an O/O CMC structure by this technique leads to an improved broadband characteristic compared to sandwich structures with dissimilar materials. FIGS. 2A-2C show the insertion loss (s21) parameter simulation of 3 silica samples: The first sample is silica with 90% relative density, whereas the second one is an A-type sandwich composed of silica as low and another material as high dielectric constant (3 times of silica) material. The thickness of silica for this design is approximately 5 times that of the high dielectric constant skin layer. The third design is composed of equivalently-thick 4 silica layers, each layer varying in density by approximately 10%. The reflection loss for these 3 structures is simulated between 0,50-40 GHz. As it is clearly observed in FIGS. 2A-2C, the graded silica shows a loss less than 1 dB over the entire frequency spectrum, whereas the sandwich and the virgin samples exhibit losses over 1 dB at certain frequency intervals.

### REFERENCES

1 D. C. Chang, Comparison of Computed and Measured Transmission Data for the AGM-88 HARM Radome, 1993, MSc Thesis, Naval Postgraduate School.
2 B. Klauss, B. Schawallar, Modern Aspects of Ceramic Fiber Development, 2006, Advances in Science and Technology, Vol. 50, 1-8.
3 B. Clauss, Fibers for Ceramic Matrix Composites, Chapter 1, Ceramic Matrix Composites. Edited by Walter Krenkel, WILEY-VCH Verlag GmbH & Co. KGaA, 2008, 1-20.
4 Nextel Application Brochure, 1-16.

What is claimed is:

1. A method for making dielectrically-graded ceramic matrix composite structures exhibiting broadband radio frequency (RF) transparency, comprising the process step of
preparing single layers each exhibiting a dielectric constant through ceramic fabrics and fibers impregnated by ceramic slurries of a solid loading (SL) ratio, wherein the SL ratio varies between 10-90% by weight in a broader range and between 30-80% by weight in a tighter process window;
wherein one type of ceramic slurry material is configured for all of the layers, wherein the one type of ceramic slurry material assures the CTE-compatibility between the layers.

2. The method according to claim 1, wherein the ceramic fabrics woven from ceramic fibers and ceramics fabrics are impregnated by ceramic slurries of an SL ratio.

3. The method according to claim 1, wherein the ceramic slurry comprises quartz, silica, alumina, mullite, a mixture of alumina, boric oxide and silica, a mixture of alumina and yttria, zirconia and as such dielectric oxide ceramics.

4. The method according to claim 1, wherein the coated ceramic fiber comprises E-glass, quartz, silica, alumina, mullite, a mixture of alumina, boric oxide, silica, a mixture of alumina and yttria, zirconia and as such dielectric oxide ceramic fibers.

5. The method according to claim 1, wherein each impregnated fabric layer is pressed.

6. The method according to claim 1, wherein each layer of the dielectrically-graded ceramic matrix composite structure is prepared by weaving the ceramic slurry impregnated ceramic fiber around cylindrical or tubular molds for a fabrication of cylindrical or conical objects in a wet state, the dielectrically-graded ceramic matrix composite structure is then dried and fired.

7. Graded ceramic matrix composite structures comprising radomes produced by the method according to claim 1.

8. The graded ceramic matrix composite structures according to claim 7, wherein in the method, the ceramic fabrics woven from ceramic fibers and ceramics fabrics are impregnated by ceramic slurries of an SL ratio.

9. The graded ceramic matrix composite structures according to claim 7, wherein in the method, the ceramic slurry comprises quartz, silica, alumina, mullite, a mixture of alumina, boric oxide and silica, a mixture of alumina and yttria, zirconia and as such dielectric oxide ceramics.

10. The graded ceramic matrix composite structures according to claim 7, wherein in the method, the coated ceramic fiber comprises E-glass, quartz, silica, alumina, mullite, a mixture of alumina, boric oxide, silica, a mixture of alumina and yttria, zirconia and as such dielectric oxide ceramic fibers.

11. The graded ceramic matrix composite structures according to claim 7, wherein in the method, each impregnated fabric layer is pressed.

12. The graded ceramic matrix composite structures according to claim 7, wherein in the method, each layer of the dielectrically-graded ceramic matrix composite structure is prepared by weaving the ceramic slurry impregnated ceramic fiber around cylindrical or tubular molds for a fabrication of cylindrical or conical objects in a wet state, the dielectrically-graded ceramic matrix composite structure is then dried and fired.
